(19) United States
(12) Patent Application Publication
(10) Pub. No.: US 2010/0192753 A1
(43) Pub. Date: Aug. 5, 2010

(54) KARAOKE APPARATUS

(75) Inventors: Jianping Gao, Shanghai (CN); Xingwei Ni, Shanghai (CN)

Correspondence Address: LOWE HAUPTMAN HAM & BERNER, LLP, 1700 DIAGONAL ROAD, SUITE 300, ALEXANDRIA, VA, 22314, US

(73) Assignee: MULTAK TECHNOLOGY DEVELOPMENT CO., LTD, Shanghai (CN)

(21) Appl. No.: 12/666,543

(22) PCT Filed: Mar. 3, 2008
(86) PCT No.: PCT/CN08/00425

§ 371 Date: Dec. 23, 2009

(30) Foreign Application Priority Data
Jun. 29, 2007 (CN) 200720071889.8
Jun. 29, 2007 (CN) 200720071890.0
Jun. 29, 2007 (CN) 200720071891.5

(51) Int. Cl. G10H 1/36

(52) U.S. Cl. 84/610

(57) ABSTRACT

A karaoke apparatus includes a sound effect processing system provided in a microprocessor. The system decodes standard song data from an internal storage or an external storage connected to an extended system interface by a song decoding module; corrects pitches of sing voices by a pitch correcting system, so the pitches of the singing voices are corrected to the pitches of the standard song or close to the pitches of the standard song. The singing voices are processed with harmony adding, tonal modification and speed-changing by a harmony adding system to produce an effect of chorus being composed of three voice parts. A pitch evaluating system is used for comparing the pitch sequence of the singing voices with the pitch sequence of the standard song to draw a voice graph so as to visually show a difference between the pitches of the singing voices and the pitches of the standard song, while providing score and comment of the singing voices. Therefore, a singer can be aware of the effect of his/her performance to immediately so as to increase the amusement in a karaoke singing.

### TECHNICAL FIELD

The present invention relates to a karaoke apparatus which is particularly appropriate to karaoke singing.

### PRIOR ART

In order to encourage karaoke singing and improve the performance of the karaoke singing, harmony is often added into the voice of the singer in some conventional karaoke apparatus. For example, a harmony three diatonic degrees higher than the theme is added by the karaoke apparatus to reproduce a composited sound of said harmony and the singing. In general, this harmonic function is achieved by moving a tone of the singing voice picked up by a microphone to generate a harmony synchronized with the speed of the singing voice. However, in these conventional karaoke apparatus, the timbre of the generated harmony is as same as that of the actual singing voice of the karaoke singer, therefore the singing performs very flatly. In order to bettering the singing effect of a karaoke singer during the singing with the karaoke mike, various karaoke apparatuses, such as synchronization or reverberation for correcting sound effect are designed. The first object for each singer is to sing accurately in tone so as to achieve a good performance. If it is enable to correct the pitch of the singing by an automatic correction system, more accurate and standard the singing effect has been made, more amusement will be brought to the singer. Most of the conventional karaoke apparatus also include a scoring system that provides a score for evaluating the singing effect of the singer. However, the principle of those conventional scoring apparatuses is to set N numbers of sampling points in each song and determine whether voices are input at these sampling points. This type of scoring is rather simple in that it only determines whether there is voice input or not, but does not determine the tone accuracy and melody accuracy, so that it can not supply an apparent impression to the singer, and moreover, it also can not reflect the difference between the singing effect and the standard sing of the original.

### SUMMARY OF THE INVENTION

A technical problem solved by the present invention is to provide a karaoke apparatus, which is capable of correcting pitch of the singing voices, adding harmony to produce a harmony effect composed of three voice parts, and providing score and comments for the singing voice so as to produce dulcet timbre and apparent impression for a karaoke singer.

To achieve the above object, the present invention provides a karaoke apparatus, which comprises a microprocessor in connection with a mic, a wireless receiving unit, an internal storage, an extended system interfaces, a video processing circuit, a D/A converter, a key-press input unit and an internal display unit respectively, a pre-amplifying and filtering circuit and an A/D converter connected between the mic and the wireless receiving unit and the microprocessor, an amplifying and filtering circuit connected to the D/A converter, an AV output device respectively connected to the video processing circuit and the amplifying and filtering circuit, characterized in that the karaoke apparatus further comprises a sound effect processing system resided in the microprocessor. Said sound effect processing system comprises:

a song decoding module for decoding standard song data received by the microprocessor from the internal storage or an external storage connected to the extended system interface, and sending the decoded standard song data to subsequent systems;

a pitch correcting system for perform filtering and correcting process for the singing pitch received by the processor from the mic or through the wireless receiving unit based on the pitch of the standard song decoded by the song decoding module, so as to correct the singing pitch to the pitch of the standard song or close to the pitch of the standard song;

a harmony processing system for processing the singing through comparing the pitch sequence of the singing voices received from the mic or the wireless receiving unit with the pitch sequence of the standard song decoded by the song decoding module, analyzing and adding harmony with the singing voice, modifying the tonal and changing the speed so as to produce a chorus effect composed of three voice parts;

a scoring system for evaluating the singing through comparing the pitch sequence of the singing voices received from the mic or the wireless receiving unit with the pitch sequence of the standard song decoded by the song decoding module to illustrate a voice graph which apparently presents the difference between the singing pitch and the pitch of the original standard song, and provides score and comment for the singing;

a synthetic output system respectively connected to the song decoded module, the pitch correcting system, the harmony adding system and the pitch evaluating system, for mixing the voice data output from the three systems, controlling the volume of the voice data and outputting the voice data after volume controlling.

The karaoke apparatus of the present invention is remarkably advantageous for that:

due to the pitch correcting system included in the sound effect processing system in the microprocessor according to the structure of the present invention, the pitch of the singing voices can be corrected to the pitch of the standard song or close to the pitch of the standard song;

due to the harmony adding system included in the sound effect processing system embedded in the microprocessor according to the invention, the singing voices can be processed with harmony adding, tonal modification, and speed-changing, to produce an effect of chorus being composed of three voice parts.

due to the pitch evaluating system included in the sound effect processing system in the microprocessor according to the invention, a voice graph, on which the dynamic pitch of the singing voices is compared with the pitch of the standard song, can be illustrated, and score and comment can be provided as well, so the singer are aware of his or her performance effect immediately to increase the amusement in the karaoke singing.

### BRIEF DESCRIPTION OF THE DRAWINGS

FIG. 1 is a diagram of an embodiment of a karaoke apparatus in accordance with the present invention;

FIG. 2 is a diagram of an embodiment of a preamplifying and filtering circuit in accordance with the present invention;

FIG. 3 is a diagram of an embodiment of a video processing circuit in accordance with the present invention;

FIG. 4 is a diagram of an embodiment of an amplifying and filtering circuit in accordance with the present invention;

FIG. 5 is a flow chart of a sound effect processing system of the karaoke apparatus in accordance with the invention;

FIG. 6 is a diagram of a pitch correcting system in accordance with the present invention;

FIG. 7 is a flow chart of the pitch correcting system in accordance with the present invention;

FIG. 8 is a diagram of a harmony adding system in accordance with the present invention;

FIG. 9 is a flow chart of the harmony adding system in accordance with the present invention;

FIG. 10 is a diagram of a pitch evaluating system in accordance with the present invention; and

FIG. 11 is a flow chart of the pitch evaluating system in accordance with the present invention;

### DETAILED DESCRIPTION OF THE EMBODIMENTS

A karaoke apparatus in according with the present invention is described in detail hereinafter with reference to accompanying drawings.

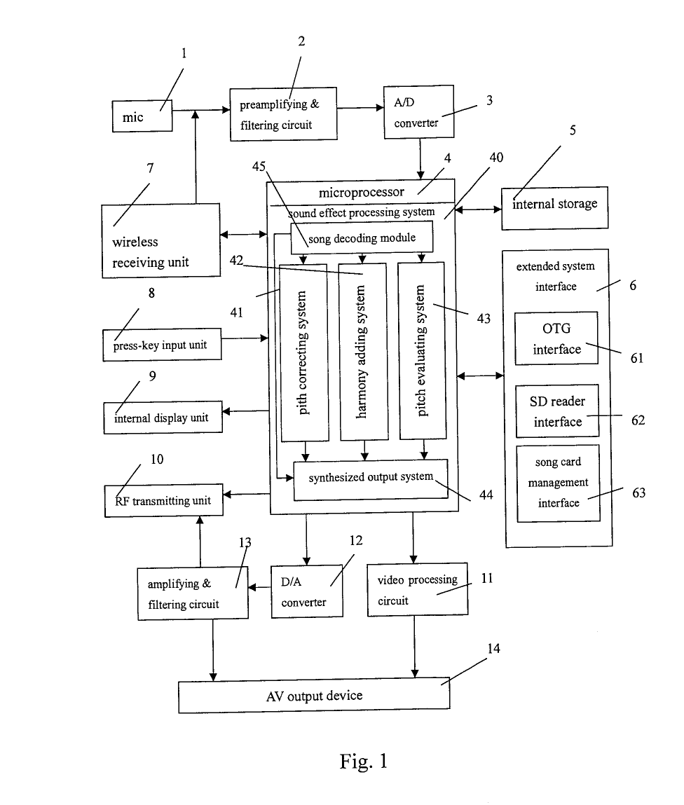

As shown in FIG. 1, a karaoke apparatus according to the invention comprises a microprocessor 4, a mic 1, a wireless receiving unit 7, an internal storage 5, extended system interfaces 6, a video processing circuit 11, a D/A converter 12, a key-press input unit 8 and an internal display unit 9 respectively connected to the microprocessor 4, a preamplifying and filtering circuit 2 and A/D converter 3 connected between the mic 1 and the wireless receiving unit 7 and the microprocessor 4, an amplifying and filtering circuit 13 connected to the D/A converter 12, an AV output device 14 respectively connected to the video processing circuit 11 and the amplifying and filtering circuit 13, and a sound effect processing system 40 provided in the microprocessor 4.

As shown in FIG. 1, the sound effect processing system 40 includes song decoding module 45, a pitch correcting system 41, a harmony adding system 42 and a pitch evaluating system 43 each connected to the song decoding module 45, and a synthesized output system 44 respectively connected to song decoding module 45, the pitch correcting system 41, the harmony adding system 42 and the pitch evaluating system 43.

The mic 1 is a microphone of a karaoke transmitter for collecting signals of singing voices.

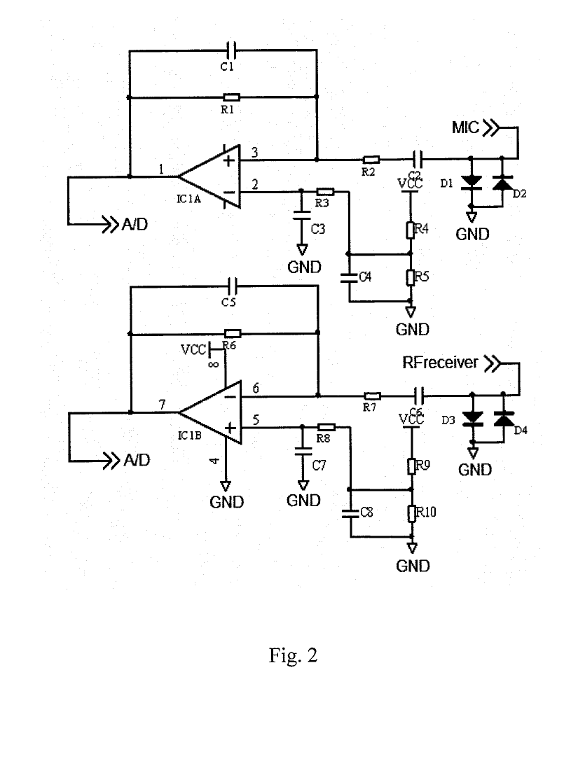

FIG. 2 illustspeeds a structure of an embodiment of the preamplifying and filtering circuit 2. As shown in FIG. 2, the signals of singing voices from the mic 1 (or the wireless receiving unit 7) is coupled to an inverted amplifying first-order low-pass filter ICLA (or ICLB) via a capacitor C2 (or C6). In this embodiment, the filter amplifies the signals with a multiple K=−R1/R2(or −R6/R7), and signals with the frequency f=1/(2πR1C1)=1/(2πR6C5) are filtered out. In this embodiment, the frequency f equals to 17 kHz. The preamplifying and filtering circuit 2 is used to amplify and filter the signals of singing voices collected by the mic 1 or the wireless receiving unit 7. The filtering is used to filter out useless high-frequency signals so as to purify the signals of the singing voices.

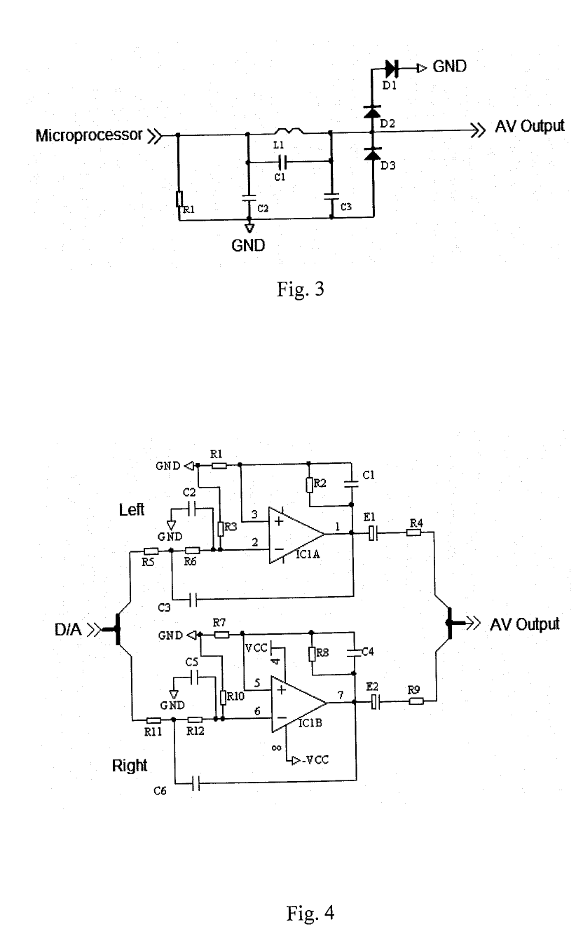

FIG. 3 illustspeeds a structure of an embodiment of the video processing circuit 11. As shown in FIG. 3, the capacitors C2, C3 and an inductance L1 constitute a low-pass filtering to filter out high-frequency interferences for improvement of video effect. Diodes D1, D2 and D3 limit an electric level at a video output interface between −0.7 V˜1.4V to prevent the karaoke apparatus from being statically damaged by video display device such as TV

FIG. 4 illustspeeds a structure of an embodiment of the amplifying and filtering circuit 13. As shown in FIG. 4, the amplifying and filtering circuit 13 comprises two (left and right) forward amplifiers IC1A and IC1B, and two low-pass filters being composed of R6, C2 and R12, C5, respectively. In this embodiment, an amplifying multiple K=R8/R7=R2/R1, and a cut-off frequency f=20 kHz. The amplifying and filtering circuit 13 is used to filter out high-frequency interference waves output from D/A converter 12 so as to clarify the output voices and increase an output power.

As shown in FIG. 1, in this embodiment, the A/D converter 3 is used in I2S mode. The A/D converter 3 converts the analog signals of singing voices into digital signals of the singing voices, and transmits the data signals to the microprocessor 4 which processes the digital signals.

The D/A converter 12 converts the data signals from the microprocessor 4 into analog signals of the voices, and transmits the analog signals to the amplifying and filtering circuit 13.

As shown in FIG. 1, in this embodiment, the wireless receiving unit 7 is a unit receiving signals of singing voices and key-press signals from one or more receiving path(s) of wireless karaoke microphone. Each receiving path of the wireless receiving unit 7 has five channels (for example, five channels of a center frequency of 810M includes 800M, 805M, 810M, 815M, 820M, however, the center frequency and arrangement of the channels are not limited to the above example). The path can be switched between the channels by the user as required for preventing wireless signals of the same type of products and other products from interfering with each other. The wireless receiving unit sends the received signals of singing voices to the preamplifying and filtering circuit 2 and sends the key-press signals to the microprocessor 4. In this embodiment, the wireless receiving unit 7 is a product as described in China Patent Number 200510024905.3.

As shown in FIG. 1, the internal storage 5 connected to the microprocessor 4 is used for storing programs and data. In this embodiment, the internal storage 5 includes NOR-FLASH (which is a flash chip applicable to be used as a program storage), NAND-FLASH (which is a flash chip applicable to be used as a data storage), and SDRAM (synchronous DRAM).

As shown in FIG. 1, in this embodiment, the extended system interfaces 6 are used for extended external storages. The extended system interfaces include an OTG (an abbreviation of USB On-The-Go) interface 161, which can be used for interconnecting various devices or mobile devices and can transfer data between the devices without an Host; a SD card reader interface 62; and a song card management interface 63. The karaoke apparatus can be communicated with a PC or read/write a USB disk (flash disk, which is a micro high capability mobile storage and uses Flash Memory as a storage medium) via the OTG interface 161. A SD card (Secure Digital Memory Card, which is a storage device based on semiconductor flash memory) and its compatible card can be read/written via the SD card reader interface 62. The song card management interface 63 is used for reading a portable card storing song data under a copyright protection.

As shown in FIG. 1, the microprocessor 4, as a core chip of the karaoke apparatus, is model AVcore-02 chip in this embodiment. The microprocessor 4 reads program or data from the internal storage 5 or data from the external storage connected to the extended system interface 6 to initialize the system. The data includes data of background video, data of song information, data of user configuration etc. After initialization, the microprocessor outputs video signals (displaying background pictures and information of song list) into the video processing circuit 11, outputs display signals (displaying a state of playing and information of a selected song) into the internal display unit 9, and receives key-press signals from the wireless receiving unit 7 and key-press signals from the key-press input unit 8 (key-presses includes play control keys, function control keys, direction keys, numeral keys etc.) to control the karaoke system by the user. The microprocessor receives voice data from the A/D converter 3 and process the voice data using the built-in pitch correcting system 41, a harmony adding system 42 and a pitch evaluating system 43. The song decoding module decodes the song data. The synthesized output system 44 synthesizes the processed data and outputs synthesized and controlled voice data into the D/A converter 12. The D/A converter converts the digital signals into video data and output into the video processing circuit 11. The microprocessor reads user control signals from the wireless receiving unit 7 or key-press input unit 8 to perform operations of, for example, volume adjusting, song selecting, play controlling etc. The microprocessor can read song data (including MP3 data and MIDI (Music Instrument Digital Interface) data) from the internal storage 5 or from external storage 5 connected to the extended system interface 6, and saves the voice data from the mic 1 or wireless receiving unit 7 into the internal storage 5 or external storage. The microprocessor can control an operation of a RF transmitting unit 10 based on a using requirement. For example, when a radio is used as a sound output device, the RF transmitting unit 10 is powered on, otherwise is powered off.

The key-press input unit 8 can input control signals using the keys. The microprocessor 4 detects whether the keys are pressed by the input unit 8 and receives the key-press signals.

The internal display unit 9 is mainly used for displaying the state of playing of the karaoke apparatus and the information of the song in playing. The RF transmitting unit 10 outputs the audio data via the RF signals receivable by the radio to perform the karaoke singing.

As mentioned above, audio of the karaoke apparatus has two sources, wherein one source is the standard song data saved in the internal storage 5 and external storage (e.g. the USB disk, SD card, and song card) connected to the extend system interface 6, and the other source is the singing voices from the mic 1 or the wireless receiving unit 7. The microprocessor 4 reads the standard song data saved in the internal storage 5 and external storage, decodes the song data by the song decoding module 45, processes the decoded song data and output the processed song data by the synthesized output system 44. The singing voices from the mic 1 or the wireless receiving unit 4 is input into the A/D converter 3 through the preamplifying and filtering circuit 2, and is converted by the A/D converter 3 into voice data. The voice data is sent into the sound effect processing system 40 in the microprocessor 4. The sound effect of the voice data is processed by the pitch correcting system 41, harmony adding system 42, and pitch evaluating system 43, and the volume of the voice data is controlled by the synthesized output system 44. The processed voice data is than mixed with the processed song data, and the resulting audio data is sent to the D/A converter 12 by the microprocessor and converted into audio signals. The resulting audio signals are output into the AV output device through the amplifying and filtering circuit 13.

As mentioned above, in other words, the sources of the audio data streams include standard song data and singing voices. MP3 data in the standard songs is processed with a MP3 decoding to generated PCM data, and the PCM data is processed with a volume controlling to become a target data 1. MIDI data in the standard songs is processed with a MIDI decoding to generated PCM data, and the PCM data is processed with a volume controlling to become a target data 2. The singing voices are processed with a A/D converting to generated voice data, and the voice data is processed by the harmony adding system, the pitch correcting system, and a mixer to become a target data 3. The target data 1 and 3, or the target data 2 and 3 is mixed to generated resulting data, and the resulting data is D/A converted into audio signals output.

The song decoding module 45 is used for reading standard song data from the internal storage 5 and the external storage (such as USB disk, SD card, and song card) connected to the extended system interface 6, decodes the song data, and sends the decoded data into pitch correcting system 41, harmony adding system 42, and pitch evaluating system 43 for sound effect processing and into the synthesized output system 44 for outputting standard song data.

The synthesized output system 44, used for mixing the data processed by the above systems and processing with the sound controlling, is respectively connected to the song decoding module 45, pitch correcting system 41, harmony adding system 42 and pitch evaluating system 43. The synthesized output system 44 processes the voice data processed by the pitch correcting system 41, harmony adding system 42 and pitch evaluating system 43 (in the state of playing) or non-processed voice data (in the state of non-playing) with a sound controlling. Three groups of data processed with the sound controlling are mixed (with a plus operation) and output into the D/A converter.

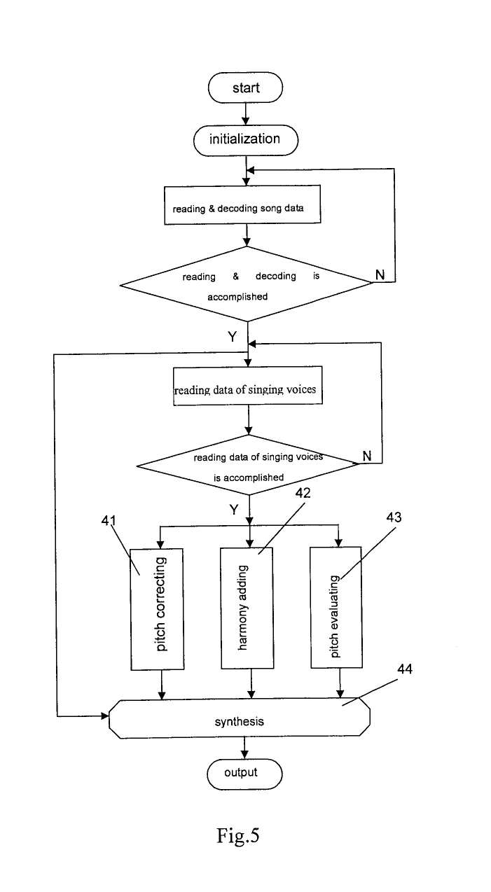

FIG. 5 is a flow chart of the sound effect processing system of the karaoke apparatus according to the invention. As shown in FIG. 5, the sound effect processing system 40 built-in the microprocessor 4 starts. After the program and data are read from the internal storage and initializations of all modules are completed, the song decoding module 45 starts to read standard song data and decodes, for example, MP3 or MIDI files into PCM (Pulse Code Modulation) data which can be accepted and operated by the sound effect processing system. The decoded standard song data are respectively input into the pitch correcting system 41, harmony adding system 42, pitch evaluating system 43, and synthesized output system 44 for being processed by these systems. At the same time, sound effect processing system obtains the singing voice data of the singer by the mic or the wireless receiving unit, and transfers the singing voice data into the pitch correcting system 41, the harmony adding system 42 and pitch evaluating system 43 so as to correct pitch, add harmonies and evaluate the pitch for the singing voices by using the decoded standard song. The singing voices processed by the sound effect processing system and the encoded standard song are mixed (added) in the synthesized output module and are output after being processed with a volume controlling.

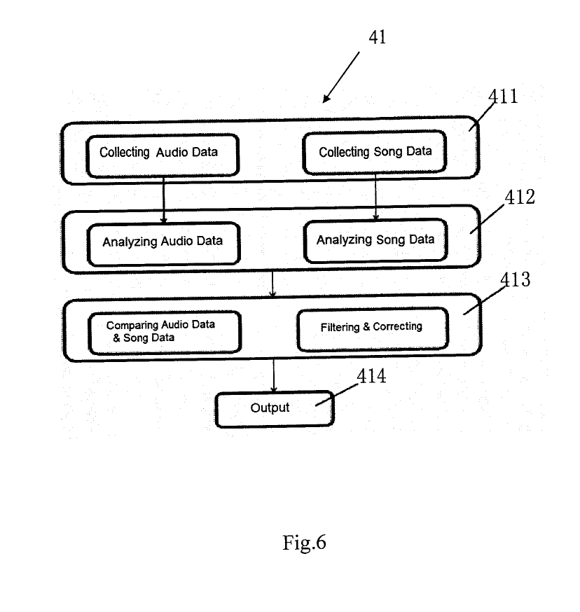

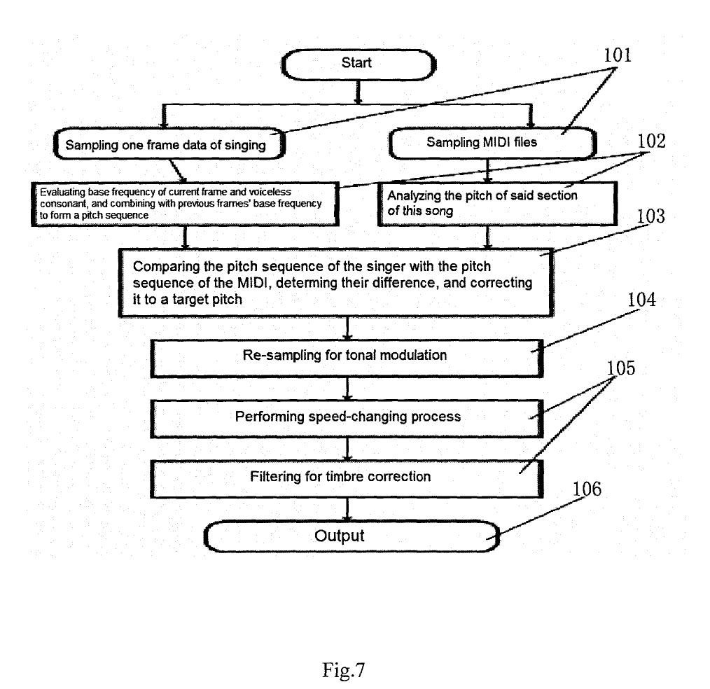

FIG. 6 is a diagram of a structure of the pitch correcting system 41 of the sound effect processing system 40 built-in the microprocessor 4. The pitch correcting system 41 is used for filtering and correcting the pitch of the singing voices received from the mic or the wireless receiving unit and the pitch of the standard song decoded by the song decoding module, so that the pitch of the singing voices is corrected to reach or close to the pitch of the standard song. As shown in FIG. 6, the pitch correcting system 41 includes a pitch data collecting module 411, a pitch data analyzing module 412, a pitch correcting module 413 and output module 414. The pitch data collecting module 411 collects the pitch data of singing voices received by the microprocessor 4 and the pitch data of the standard song (decoded by the song decoding module), and sends the pitch data into the pitch analyzing module 412. The pitch analyzing module 412 respectively analyzes the pitch data of the singing voices and the pitch data of the standard song, and sends the analyzing results into the pitch correcting module 413. The pitch correcting module 413 compares the pitch data and melody of the singing voices with those of the standard song, and filters and corrects the pitch data and melody of the singing voices based on those of the standard song. The filtered and corrected pitch data and melody of the singing voices is output to the synthesized output system 44 via the output module 414. The flow is illustspeedd in FIG. 7.

FIG. 7 is a flow chart of the pitch correcting system 41. As shown in FIG. 7, in a first step 101, the pitch data collecting module 411 respective collects pitch data of the singing voices and pitch data of standard song (MIDI files). In this embodiment, a data sampling of 24 bit/32K is performed. For example, for sampling a frame of sine wave of 478 Hz, a sampling formula is:

s(n)=10000×sin(2π×n×450/32000), wherein 1≦n≦600, n denotes the ordinal of the data, and s(n) denotes the value of the n^{th} sampled data. The data obtained by sampling is sent to the pitch data analyzing module 412, and saved in the internal storage.

In a second step 102, the pitch data analyzing module 412 analyzes the data obtained by the pitch data collecting module 411 and measures a voiceless consonant of a frame base frequency using an AMDF (Average Magnitude Difference Function) method, and this voiceless consonant and those in the past frame base frequencies constitute a sequence of pitches. A frame of the voice including 600 samples is performed a pitch measurement using the quickly-operated AMDF method, and compared with previous frames to eliminate frequency multiplication. A maximum integral multiplication of a base frequency duration equal or less than 600 is intersected as a length of the current length. The remainder data is left to the next frame. Because the frame of the voiceless consonant has a small energy, a high zero-crossing speed, and a small difference speed (the speed of a maximum value to a minimum value of differential sums during the AMDF), the voiceless consonant can be determined by synthesizing values of the energy, zero-crossing speed, and difference speed. Threshold values of the energy, zero-crossing speed, and difference speed are set respectively. When all the three values are larger than the respective threshold values, or two of the values are larger than the respective values and the remainder one is close to its value, it is determined that the voice is a consonant. The character values (pitch, frame length, and vowel/consonant determination) of the current frame is established. The character values of the current frame and the character values of the latest several frames constitute voice characters of a period of time.

For example, during AMDF, the duration length T of the frame obtained by the standard AMDF method with a step length of 2.

In case 30<t<300, calculation is performed by the following formula:

$$d ( t ) = {\sum }_{n = 0}^{150} \vert s ( n \times 2 + t ) - s ( n \times 2 ) \vert$$

T is searched based on

$$d ( T ) = {min}_{20 < t < 200} d ( t ) ,$$

and the calculated T is the duration length of the current frame.

(Duration length×Frequency=Sampling Speed 32000). In the above formula, t is a duration length used for scanning. The s(n) is substituted into the formula, and the calculated T is 67.

[600/67]×67=536, wherein “[ ]” means round the number therein (same as below). The first 568 samples in this frame are used as the current frame, and the remainder data is left for the next frame.

In step 103, the pitch correcting module 413 measures the base frequency and voiceless consonant of the current frame of the singer's singing voices by the AMDF, and the current base frequency and the previous several base frequencies constitute a sequence of pitches. Namely, the pitch correcting module 413 finds out the difference between the pitch sequence of the singing voices and the pitch sequence of the standard song transferred from the pitch analyzing module 412, and determines the target pitch required for correction. Music files corresponding to the MIDI files are used as the standard song, and pitches of the music files are analyzed. At first, consonants or shortly continual vowels (below three frames) are passed through. Secondary, the voice characters of the continual vowels are compared with those of the standard MIDI file to determine the rhythm. It is determined whether the singing voices is in advance of or behind the standard song based on the start time of the vowels and the start time of music notes of the MIDI. Thus, the desired pitch for the singer is obtained. If a difference between the pitch of the current frame and the pitch of the standard song is less than 150 cents, then the target pitch is set as a correct pitch. Otherwise, a pitch of a music note closest to the pitch of the current frame is searched and set as the target pitch. For example, when the current MIDI note is 60, a frequency corresponding to 60 is 440 Hz and a duration length is 32000/440=73. 73/67=1.090, is less than the value 1.091 (=2^{150/1200}) corresponding to the threshold value of 150 cents. The target duration length is set as 73.

In addition, for example, when the current MIDI note is 64, its corresponding duration length is 97 (obtained by table search). 97/71>1.366, is larger than the threshold value, and a distance duration length 73 is found out in a note-duration table. A minimum note is 58, and its corresponding duration length is 69. Thus, the target duration length is set as 69.

In a fourth step 104, the pitch correcting module 413 processes the above result with a tonal modification by using the PSOLA (Pitch Synchronous Overlap Add Method) cooperated with an interpolation re-sampling. For example, re-sampling tonal modification modifies data of one frame by using the interpolation re-sampling method.

In case 1≦n≦536/67×73=584,

m=n×67/73

b(n)=a([m]×([m]+1−m)+a([m]+1)×(m−[m]), wherein m means the number of a sample point before re-sampling, then a sequence b(n) is obtained.

After the re-sampling, the length of each frame will be changed.

In a step 105, the pitch correcting module 413 processes the tonally modified data with an frame-length adjustment (e.g. speed-changing) by using the PSOLA, and with a timbre correction by using filtering. That means performing frame-length adjustment and timbre correction for the tonally modified data, and finally adding with the tonal modification distance related parameter continuous three order FIR (Finite Impulse Response) high-pass filtering (in case of the falling tone) or a low-pass filtering (in case of the rising tone): 1−az⁻¹+az⁻², wherein a is in proportion to the degree of the tonal modification and varies between 0-0.1. The filtering is used for correcting a timbre change caused by the PSOLA. The frame-length adjustment is performed by using the standard PSOLA procedure, which is an algorithm to process a pitch with a speed-changing based on the pitch measurement. An integral number of duration lengths are added into or removed from a waveform by using a linear superposition.

For example, when an input length of the current frame includes 536 samples, the output length includes 584 samples, increasing by 48 samples. It is less than the target duration of 64. No processing must be performed. This error of 48 samples is accumulated and will be processed in the next frame.

If 40 samples have be accumulated in the previous frames, then total accumulated length error of the current frame is 88 samples. It is larger than the duration length of 73. Thus, the length needs to be adjusted by using PSOLA to eliminate a duration length.

In case 1≦n≦584−73=511,

c(n)=(b(n)×(511−n)+b(n+73)×n)/511, then a sequence c(n), of which the length is decreased, is obtained.

Filtering: Because the pitches will be changed by re-sampling, it affects an spectrum envelope of the current frame and the timbre. The rising tone will slant the spectrum to high frequency, so a high pass filtering is needed. The falling tone will slant the spectrum to low frequency, so a low pass filtering is needed. The filtering is performed by a three order FIR (Finite Impulse Response): 1−a⁻¹+a⁻². When a>0, it is a high pass, otherwise it is a low pass.

When the length of the original frame is 67 and the length of the target duration is 73, the frequency is lowered. The speed of 73/67 equals to 1.09.

A filtering coefficient a=0.1/ln(1.09)×ln(1.09)=0.1. The former 1.09 is a maximum threshold value of the tonal modification, and the later 1.09 is the speed of the current change. Therefore, the filtering is:

d(n)=c(n)−c(n−1)×0.1+c(n−2)×0.1.

In a sixth step 106, corrected voice data (the final corrected result d(n)) is output.

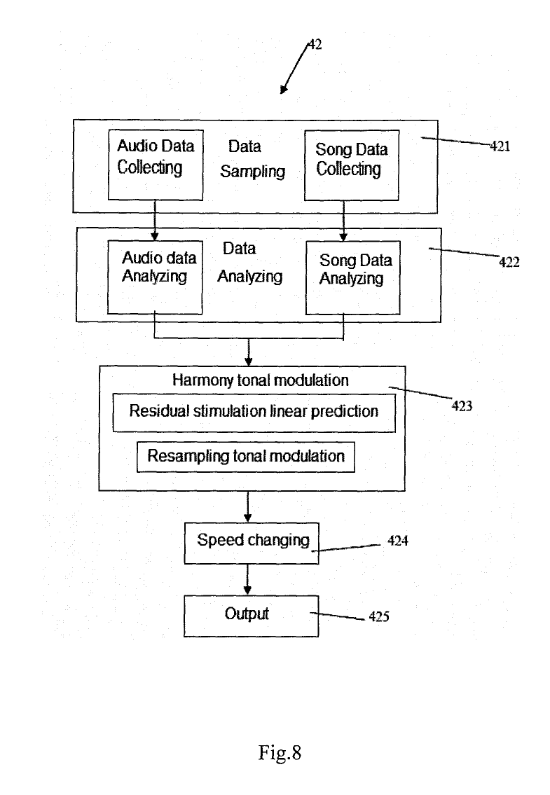

FIG. 8 is a diagram of a structure of an embodiment of the harmony adding system 42 according to the invention. The harmony adding system 42 is used for comparing the pitch sequence of the singing voices received from the mic or the wireless receiving unit by the microprocessor with the pitch sequence of the standard song decoded by the song decoding module, analyzing and processing the pitch sequence of the singing voices. Then, the singing voices are processed with harmony adding, tonal modification and speed-changing to produce an effect of chorus being composed of three voice parts. As shown in FIG. 8, in this embodiment, the harmony adding system 42 includes a harmony data collecting module 421, a harmony data analyzing module 422, harmony tone modifying module 423, harmony speed-changing module 424, and harmony output module 425. The harmony data collecting module 421 collects the pitch sequence of the singing voices received by the microprocessor and the pitch sequence of the standard song with chords decoded by the song decoding module, and sends them into the harmony data analyzing module 422. The harmony data analyzing module 422 measures the two pitch sequences of the singing voices and the standard song transferred from the harmony data collecting module, compares the voice character of the singing voices with the chord sequence of the standard song, finds out proper pitches for upper and lower voice parts being capable of forming natural harmonies, and sends obtained harmonies into the harmony tone modifying module 423. The harmony tone modifying module 423 modifies the tone of the obtained harmonies by using an RELP (Residual Excited Linear Prediction) method and an interpolation re-sampling method, and sends obtained harmonies into the harmony speed-changing module 424. The harmony speed-changing module 424 processes the obtained harmonies from the harmony tone modifying module 423 with frame-length adjusting and speed-changing by using the PSOLA method to form harmonies being composed of three voice parts. The harmonies are then output to the synthesized output system 4 by the harmony output module 425.

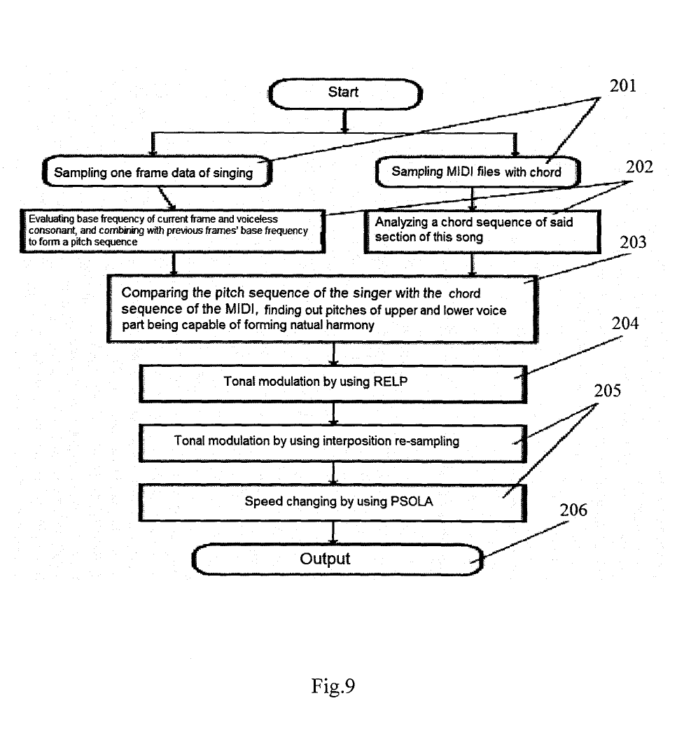

FIG. 9 is a flow chart of an embodiment of the harmony adding system 42. As shown in FIG. 9 (in this embodiment, the harmony adding system is denoted as I-star technology), in a first step 201, the harmony adding system 42 starts, and the harmony data collecting module 421 collects data of singing voices and data of standard song with chords, which is song data decoded from a MIDI file with chords by the song decoding module in this embodiment, by a data sampling of 24 bit/32K. The sampled data is saved in the internal storage. For example, for sampling a frame of sine wave of 478 Hz, the sampling formula is: s(n)=10000×sin(2π×n×450/32000), wherein 1≦n≦600 , n denotes the ordinal of the data, and s(n) denotes the value of the n^{th} sampled data.

In a second step 202, the harmony data analyzing module 422 analyzes the sampled data to obtain a pitch sequence of the data of the standard song with the chords and a pitch sequence of the data of the singing voice. A frame of the voice including 600 samples and sampled by speed of 32 k is performed a pitch measurement using the quickly-operated AMDF method, and compared with previous frames to eliminate frequency multiplication. A maximum integral multiplication of a base frequency duration equal or less than 600 is intersected as a length of the current length. The remainder data is left to the next frame. Because the frame of voiceless consonant has a small energy, a high zero-crossing speed, and a small difference speed (the speed of a maximum value to a minimum value of differential sums during the AMDF), the voiceless consonant can be determined by synthesizing values of the energy, zero-crossing speed, and difference speed. Threshold values of the energy, zero-crossing speed, and difference speed are set respectively. When all the three values are larger than the respective threshold values, or two of the values are larger than the respective values and the remainder one is close to its value, it is determined that the voice is a consonant. The character values (pitch, frame length, and vowel/consonant determination) of the current frame is established. The character values of the current frame and the character values of the latest several frames constitute voice characters of a period of time.

In this embodiment, the harmony adding system 42 analyzes the pitch of the data of the standard song from the MIDI file with chords to obtain the chord sequence.

During AMDF, the duration length T of the frame obtained by the standard AMDF method with a step length of 2.

In case 30<t<300, calculation is performed by the following formula:

$$d ( t ) = {\sum }_{n = 0}^{150} \vert s ( n \times 2 + t ) - s ( n \times 2 ) \vert$$

T is searched based on

$$d ( T ) = {min}_{20 < t < 200} d ( t ) ,$$

and the calculated T is the duration length of the current frame.

(Duration length×Frequency=Sampling Speed 32000). The s(n) is substituted into the formula, and the calculated T is 67.

[600/67]×67=536, wherein “[ ]” means round the number therein (same as below). The first 568 samples in this frame are used as the current frame, and the remainder data is left for the next frame.

In a third step 203, the harmony analyzing module 422 determines a target pitch. The pitch sequence is compared with the chord sequence of MIDI, and proper pitches for upper and lower voice parts being capable of forming natural harmonies are found out. The upper voice part is chord voice, of which pitch is higher than that of the current singing voice by at least two semi-tones, and the lower voice part is chord voice, of which pitch is lower than that of the current singing voice by at least two semi-tones. Depended on the target pitch, when the current chord is a C-tone chord, it is a chord being composed of three tones 1 3 5. Namely, the following MIDI notes are chord tones:

60+12×k, 64+12×k, 67+12×k, wherein k is an integer.

By table searching, a note closest to the pitch of the current frame is 70. Chord tones closest to 70 and different from 70 by at least two semi-tones are 67 and 76. The corresponding duration lengths are 82 and 49, which are the target duration lengths of the two respective voice parts.

In a fourth step 204, the harmony tone modifying module 423 modifies the tones by using the RELP (Residual Excited Linear Prediction) method, which can maintain the timbre well, and an interpolation re-sampling method. The detailed processing is described as below.

The current frame together with the second half of the previous frame is superposed with the Hanning window. The prolonged and window superposed signals is processed with a 15 order LPC (Linear Predictive Coding) analysis by using the covariance method. The original signals which are not superposed with the Hanning window is processed with an LPC filtering to obtain residual signals. In case of falling tone, equal to prolonging duration, the residual signals in each duration is filled with 0 so as to prolong it to target duration. In case of rising tone, equal to shortening duration, the residual signals in each duration are cut off from the beginning of the signals by the length of the target duration. This ensures the spectrum variation of the residual signals of each duration is minimized while the tone is modified. An LPC inverse filtering is then performed.

The signals of the first half of the current frame recovered by the LPC inverse filtering are linearly superposed with the signals of the second half of the previous frame to ensure a waveform continuity between the frames.

Because a vast RELP tone modification will affect the timbre, a portion of tone modification is performed using the interpolation re-sampling method, so that the timbre and tone will be sweet.

The tone is firstly modified with a speed of 1.03 by using the RELP method, and then modified with the speed of 1.03 by using the re-sampling method and the PSOLA method.

For example, in the current frame, 82/1.03=80, 49×1.03=50. Thus, the current frame is processed with a tone modification as follows:

1. The original signals s(n) is processed by the RELP tone modification to change a duration of 67 into a duration of 80, and signals p₁(n) are obtained,

2. The signals p₁(n) is processed by the PSOLA tone modification to change the duration of 80 into a duration of 82, and signals h₁(n) are obtained.

3. The original signals s(n) is processed by the RELP tone modification to change a duration of 67 into a duration of 50, and signals p₂(n) are obtained,

4. The signals p₂(n) is processed by the PSOLA tone modification to change the duration of 50 into a duration of 49, and signals h₂(n) are obtained.

The signals h₁(n) and h₂(n) are the obtained harmony of the two voice parts.

The tone modification is described in detail hereinafter.

RELP tone modification: RELP means Residual Excited Linear Predict, which linearly predicts codes of the signals, filters the predicted results to obtain the residual signals, and anti-filters the residual signals after being processed to recover the voice signals.

1. Window Superposing:

In case the data of the previous frame is r(n), and its length is L₁. Later 300 samples of the previous frame are combined with the current frame (length L₂) to form a prolonged frame. Hanning windows are respectively superposed at 150 samples at both ends.

Namely,

$${s}^{′} n = r ( n + {L}_{1} - 300 ) \times ( 0.5 \times cos \frac{2 π n}{300} )$$

$$n < 150$$

$${s}^{′} n = r ( n + {L}_{1} - 300 ) , \\ 150 \leq n < 300$$

$${s}^{′} n = s ( n - 300 ) , \\ 300 \leq n < 150 + {L}_{2}$$

$${s}^{′} n = r ( n - 300 ) \times ( 0.5 \times 0.5 \times cos \frac{2 π ( n - {L}_{2} )}{300} ) , \\ 150 + {L}_{2} \leq n < 300 + {L}_{2}$$

The obtained length of signals L=300+L₂.

2. LPC Analysis:

The signal after window superposing is performed with a 15 order linear predictive coding (LPC) analysis by using an autocorrelation method. The method is described as below.

The autocorrelation sequence is calculated:

$$r ( j ) = {\sum }_{n = j}^{L} {s}^{′} ( n ) {s}^{′} ( n - j ) , 0 \leq j \leq 15$$

The sequence aⱼ⁽ⁱ⁾ is obtained by a recursion formula, wherein 1≦i≦15, 1≦j≦i

E₀=r(0)

$${k}_{i} = \frac{r ( i ) - {\sum }_{j = 1}^{i - 1} {a}_{j}^{( i - 1 )} r ( i - j )}{{E}_{i - 1}} , 1 \leq i \leq 15$$

$${a}_{i}^{( i )} = {k}_{i}$$

$${a}_{j}^{( i )} = {a}_{j}^{( i - 1 ) } - {k}_{i} {a}_{i - j}^{( i - 1 )} , 1 \leq j \leq i - 1$$

In the above formulas, a is a parameter for calculation, and r is an autocorrelation coefficient.

Eᵢ=(1−kᵢ²)Eᵢ₋₁

Finally, the LPC coefficient is:

aⱼ=aⱼ^{(p)}, 1≦j≦15

For example, the autocorrelation coefficients for the original signals at beginning is calculated and the respective calculated coefficients are:

−1.2900, 0.0946, 0.0663, 0.0464, 0.0325, 0.0228, 0.0159, 0.0111, 0.0078, 0.0054, 0.0037, 0.0025, 0.0016, 0.0009, 0.0037

3. LPC Filtering:

The original signals before being prolonged and superposed window are filtered by using the LPC coefficients obtained above. The obtained signals are called residual signals.

$$r ( n ) = s ( n ) - {\sum }_{i = 1}^{15} s ( n - i ) , 1 \leq n \leq L$$

Data required for filtering the first 15 samples and beyond the range of the current frame is obtained from the last portion of the previous frame.

4. Tone Modification of the Residual Signals

r(n) is processed with a tone modification, including rising tone processing and falling tone processing.

The falling tone prolongs the duration, each one being prolonged by adding 0 at the last thereof.

For example, if a residual signal r(n) with a duration of 67 and a length of 536 needs to be falling tone processed to a duration of 80, then the residual signals after falling tone is:

$$\{ \begin{matrix}{r}_{1} ( 80 \times k + n ) = r ( 67 \times k + n ) , 1 \leq k \leq 67 \\ {r}_{1} ( 80 \times k + n ) = 0 , 68 \leq n \leq 80 ,\end{matrix} \\ 0 \leq k \leq 7 ,$$

The rising tone shortens the duration, each one being cut off directly.

For example, if a residual signal r(n) with a duration of 67 and a length of 536 needs to be rising tone processed to a duration of 50, then the residual signals after rising tone is:

r₂(50×k+n)=r(67×k+n),1≦n≦50 0≦k≦7,

5. LPC Filtering

r₁(n), r₂(n) are inversely filtered by using the LPC coefficient to recover the voice signals.

$${p}_{1}^{′} ( n ) = {r}_{1} ( n ) + {\sum }_{i = 1}^{15} {p}_{1}^{′} ( n - i )$$

$${p}_{2}^{′} ( n ) = {r}_{2} ( n ) + {\sum }_{i = 1}^{15} {p}_{2}^{′} ( n - i )$$

The first 15 samples are obtained from the last portion of the inversely filtered signals of the previous frame.

Thus, two frames of RELP tone modified signals with lengths 640 and 400 are obtained.

6. Linear Superpose Smoothing

The first duration of the inversely filtered signals of the current frame is linearly superposed on the last duration of the inversely filter signals of the previous frame.

If the two duration signals are e(n) and b(n), and the duration is T, then the two signals are transformed as below:

$$\{ \begin{matrix}{e}^{′} ( n ) = \frac{e ( n ) \times ( 2 T - n ) + b ( n ) \times n}{2 T} \\ {b}^{′} ( n ) = \frac{e ( n ) \times ( T - n ) + b ( n ) \times ( T + n )}{2 T} ,\end{matrix} \\ 1 \leq n \leq T ,$$

Tone modification with re-sampling: the data of the frame is tonally modified by the interposition re-sampling method.

Take the falling tone as example.

For 1≦n≦640/80×81=648,

m=n×80/81

b(n)=p′₁([m])×([m]+1−m)+p′₁([m]+1)×(m−[m])

then the sequence b(n) is obtained.

In a fifth step 205, the harmony speed-changing module 424 adjusts the length of the frame (i.e. speed-changing) by using a standard PSOLA processing.

After the above processing, the length of each frame is greatly changed. The PSOLA process is an algorithm to change speed of the pitches based on the pitch measurement. By using a linearly superposing method, an integer number of duration are added into or removed from the waveform.

For example, an input length of the current frame is 536, and an output length of the current frame is 648, increasing by 112 samples. It is larger than the target duration 81. The length should be adjusted by using the PSOLA processing, and several durations (one in this example) will be removed.

For 1≦n≦648−81=567

p₁(n)=(b(n)×(567−n)+b(n+81)×n)/567

Thus, a falling tone sequence p₁(n) of which length is 567 is obtained. The remainder 31 samples are superposed into the next frame.

A rising tone sequence p₂(n) of which length is 500 is obtained by using the same processing.

Thus, two voice parts are obtained to form the harmony with three voice parts.

In a sixth step 206, the final output synthesized result is harmony data with three voice parts including the singing voices, p₁(n), and p₂(n).

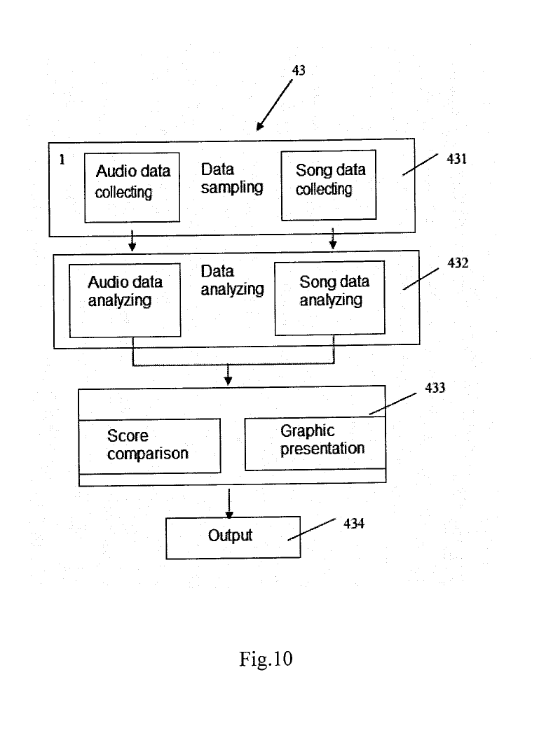

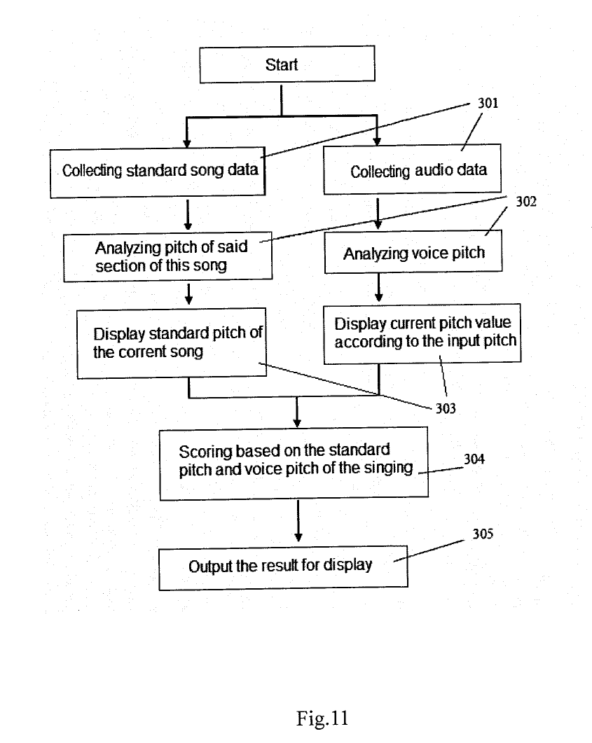

FIG. 10 is a diagram of a structure of the pitch evaluating system 43 according to the invention. The pitch evaluating system 43 is used for comparing the pitch of the singing voices received from the mic or the wireless receiving unit by the microprocessor with the pitch of the standard song decoded by the song decoding module, draws a voice graph, and provides score and comment for the singing voices based on the pitch comparing.

As shown in FIG. 10, the pitch evaluating system 43 includes an evaluation data collecting module 431, an evaluation analyzing module 432, an evaluation processing module 433 and an evaluation output module 434. The evaluation data collecting module 431 collects the pitch of the singing voices received by the microprocessor and the pitch of the standard song decoded by the song decoding module and received by the microprocessor, and sends the collected pitches into the evaluation analyzing module 432. The evaluation analyzing module 432 measures and analyzes the pitches of the singing voices and the standard song by using the quickly-operated AMDF method, finds out two voice characters during a term of time, and sends them into the evaluation processing module 433. The evaluation processing module 433, based on the two voice characters, draws a two-dimensional voice graph in a format including pitch and time. The pitch of the singing voices and the pitch of the standard song can be visually compared, and the pitch evaluating system provides score and comment for the singing voices based on the pitch comparing. The evaluation output module 434 output the score and comment into the synthesized output system 44, and displays them on the internal display unit in the microprocessor.

FIG. 11 is a flow chart of the pitch evaluating system 43. As shown in FIG. 11, in a first step 301, the evaluation data collecting module 431 converts analog signals into digital signals by the A/D converter and perform a data sampling of 24 bit/32K. The sampled data is saved into the internal storage 5 (as shown in FIG. 1). At the same time, the evaluation data collecting module 431 collects data standard song decoded by the song decoding module and from the standard song in the external storage connected to the extended system interface 6, and transfers the two types of data into the following module. The standard file of the song is MIDI file.

In a second step 302, the evaluation analyzing module 432 measures and analyzes the pitches of the collected singing voices and the standard song by using the quickly-operated AMDF method, finds out two voice characters during a term of time, and sends them into the evaluation processing module 433. In this embodiment, a frame of the voice including 600 samples and sampled by speed of 32 k is performed a pitch measurement using the quickly-operated AMDF method, and compared with previous frames to eliminate frequency multiplication. A maximum integral multiplication of a base frequency duration equal or less than 600 is intersected as a length of the current length. The remainder data is left to the next frame. Because the frame of voiceless consonant has a small energy, a high zero-crossing speed, and a small difference speed (the speed of a maximum value to a minimum value of differential sums during the AMDF), the voiceless consonant can be determined by synthesizing values of the energy, zero-crossing speed, and difference speed. Threshold values of the energy, zero-crossing speed, and difference speed are set respectively. When all the three values are larger than the respective threshold values, or two of the values are larger than the respective values and the remainder one is close to its value, it is determined that the voice is a consonant. The character value (pitch, frame length, and vowel/consonant determination) of the current frame is established. The character values of the current frame and the character values of the latest several frames constitute voice characters of a period of time.

For sampling a frame of sine wave of 478 Hz, a sampling formula is:

s(n)=10000×sin(2π×n×450/32000), where 1≦n≦600, n denotes the ordinal of the data, and s(n) denotes the value of the n^{th} sampled data.

For example, during AMDF, the duration length T of the frame obtained by the standard AMDF method with a step length of 2.

In case 30<t<300, calculation is performed by the following formula:

$$d ( t ) = {\sum }_{n = 0}^{150} \vert s ( n \times 2 + t ) - s ( n \times 2 ) \vert$$

T is searched based on

$$d ( T ) = {min}_{20 < t < 200} d ( t ) ,$$

and the calculated T is the duration length of the current frame.

(Duration length×Frequency=Sampling Speed 32000). In the above formula, t is a duration length used for scanning. The s(n) is substituted into the formula, and the calculated T is 67.

[600/67]×67=536, wherein “[ ]” means round the number therein (same as below). The first 568 samples in this frame are used as the current frame, and the remainder data is left for the next frame.

In a third step 303, the evaluation processing module 433, based on the two voice characters obtained by the evaluation analyzing module 432, draws a two-dimensional voice graph in a MIDI format including tracks, pitch and time.

For example, the two-dimensional voice graph is drawn based on the analyzed pitch data of the singing voices and of the standard song.

The horizontal coordinate of the graph representatives time, and the vertical coordinate of the graph representative pitch. When a line of lyric is shown, the standard pitch of this section is shown based on the information of the standard song. If the pitch of the singing voice is coincident with the pitch of the standard song, a continuous graph is shown, otherwise broken graph is shown.

During singing of the singer, pitches are calculated based on the input singing voices. These pitches are superposed on the standard pitches of the standard song. If a portion of pitches is coincident with the standard pitches, a superposition appears. If a portion of pitches is not coincident with the standard pitches, the superposition does not appear. By comparing the positions of the vertical coordinate, it is determined whether the singer sing properly.

In a fourth step 304, the evaluation processing module 433 provides a score. The evaluation processing module 433 determines a score by comparing the pitches of the singing voices and the standard pitches of the standard song. The evaluation is performed and shown in real-time. When a continuous time is completed, the score and comment can be provided based on points.

In a fifth step 305, the evaluating output module 434 outputs the drawn graph and score into the synthesized output system and the internal display unit.

What is claimed is:

1. A karaoke apparatus comprising: a microprocessor, a mic, a wireless receiving, an internal storage, an extended system interfaces, a video processing circuit, a D/A converter, a key-press input unit and an internal display unit respectively connected to the microprocessor, a preamplifying and filtering circuit and an A/D converter connected between the mic and the wireless receiving unit and the microprocessor, an amplifying and filtering circuit connected to the D/A converter, an AV output device respectively connected to the video processing circuit and the amplifying and filtering circuit, characterized in that the karaoke apparatus further comprises a sound effect processing system provided in the microprocessor, the sound effect processing system comprises:
a song decoding module for decoding standard song data received by the microprocessor from the internal storage or an external storage connected to the extended system interface, and sending the decoded standard song data to subsequent systems;
a pitch correcting system for perform filtering and correcting process for the singing pitch received by the processor from the mic or through the wireless receiving unit based on the pitch of the standard song decoded by the song decoding module, so as to correct the singing pitch to the pitch of the standard song or close to the pitch of the standard song;
a harmony processing system for processing the singing through comparing the pitch sequence of the singing voices received from the mic or the wireless receiving unit with the pitch sequence of the standard song decoded by the song decoding module, analyzing and adding harmony with the singing voice, modifying the tonal and changing the speed so as to produce a chorus effect composed of three voice parts;
a scoring system for evaluating the singing through comparing the pitch sequence of the singing voices received from the mic or the wireless receiving unit with the pitch sequence of the standard song decoded by the song decoding module to illustrate a voice graph which apparently presents the difference between the singing pitch and the pitch of the original standard song, and provides score and comment for the singing;
a synthetic output system respectively connected to the song decoded module, the pitch correcting system, the harmony adding system and the pitch evaluating system, for mixing the voice data output from the three systems, controlling the volume of the voice data and outputting the voice data after volume controlling.

2. The karaoke apparatus as claimed in claim 1, characterized in that the pitch correcting module comprises: a pitch data collecting module, a pitch data analyzing module, a pitch correcting module and output module, wherein the pitch data collecting module collects the pitch data of singing voices received by the microprocessor and the pitch data of the standard song decoded by the song decoding module and, and sends the pitch data into the pitch analyzing module; the pitch analyzing module respectively analyzes the pitch data of the singing voices and the pitch data of the standard song, and sends the analyzing results into the pitch correcting module; the pitch correcting module compares the analyzing results from the pitch analyzing module, filters and corrects the pitch data of the singing voices based on the pitch of the standard song, and the filtered and corrected pitch data of the singing voices is output to the synthesized output system via the output module.

3. The karaoke apparatus as claim in claim 1, characterized in that the harmony adding system comprises: a harmony data collecting module, a harmony data analyzing module, a harmony tone modifying module, a harmony speed-changing module, and a harmony output module; wherein the harmony data collecting module collects the pitch sequence of the singing voices received by the microprocessor and the pitch sequence of the standard song with chords decoded by the song decoding module, and sends them into the harmony data analyzing module; the harmony data analyzing module measures the two pitch sequences of the singing voices and the standard song transferred from the harmony data collecting module, compares the voice character of the singing voices with the chord sequence of the standard song, finds out proper pitches for upper and lower voice parts being capable of forming natural harmonies, and sends obtained harmonies into the harmony tone modifying module 423; the harmony tone modifying module modifies the tone of the obtained harmonies by using an interpolation re-sampling method, and sends obtained harmonies into the harmony speed-changing module; the harmony speed-changing module processes the synthesized harmonies from the harmony tone modifying module with frame-length adjusting and speed-changing by using the Pitch Synchronous Overlap Add method to produce harmonies being composed of three voice parts, the harmonies are then output to the synthesized output system by the harmony output module.

4. The karaoke apparatus as claimed in claim 1, characterized in that the pitch evaluating system includes an evaluation data collecting module, evaluation analyzing module, an evaluation processing module and an evaluation output module; wherein the evaluation data collecting module collects the pitch of the singing voices received by the microprocessor and the pitch of the standard song decoded by the song decoding module and received by the microprocessor, and sends the collected pitches into the evaluation analyzing module; the evaluation analyzing module measures and analyzes the pitches of the singing voices and the standard song by using the quickly-operated Average Magnitude Difference Function method, finds out two voice characters during a term of time, and sends them into the evaluation processing module; the evaluation processing module, based on the two voice characters, illustrates a two-dimensional voice graph in a format including pitch and time, the pitch of the singing voices and the pitch of the standard song can be compared in the voice graph to provide score and comment for the singing voices; and the evaluation output module output the score and comment into the synthesized output system, and displays them on the internal display unit in the microprocessor.

5. The karaoke apparatus as claimed in claim 1, characterized in that the extended system interface includes an OTG interface, an SD card reader interface and a song card management interface.

6. The karaoke apparatus as claimed in claim 1, characterized in that the karaoke apparatus further comprises a RF transmitting unit connected between the microprocessor and the amplifying and filtering circuit.
